(19) United States
(12) Patent Application Publication
(10) Pub. No.: US 2024/0054213 A1
(43) Pub. Date: Feb. 15, 2024

(54) ATTACK INFORMATION GENERATION APPARATUS, CONTROL METHOD, AND NON-TRANSITORY COMPUTER READABLE MEDIUM

(71) Applicants: NEC CORPORATION, Tokyo (JP); National Institute of Information and Communications Technology, Tokyo (JP)

(72) Inventors: Yusuke TAKAHASHI, Tokyo (JP); Shingo YASUDA, Tokyo (JP)

(73) Assignees: NEC Corporation, Tokyo (JP); National Institute of Information and Communications Technology, Tokyo (JP)

(21) Appl. No.: 18/269,361

(22) PCT Filed: Nov. 15, 2021
(86) PCT No.: PCT/JP2021/041829

§ 371 Date: Jun. 23, 2023

(30) Foreign Application Priority Data
Dec. 24, 2020 (JP) 2020-215074

(51) Int. Cl. G06F 21/55

(52) U.S. Cl. CPC G06F 21/552; G06F 2221/034

(57) ABSTRACT

An attack information generation apparatus (2000) determines, for each of a plurality of executions of a target attack, the number of occurrences of one or more events by using a log (10) in its execution period. The attack information generation apparatus (2000) determines, for each of the events, whether or not the number of occurrences of that event determined for each of the plurality of executions of the target attack satisfies a predetermined condition. The attack information generation apparatus (2000) generates attack information (30) associating the target attack with the event whose number of occurrences is determined to satisfy the predetermined condition.

### TECHNICAL FIELD

The present disclosure relates to an analysis of an attack on a computer system.

### BACKGROUND ART

As a countermeasure against attacks on a computer system (cyber-attacks), operators or the like conduct work for detecting the presence of an undetected attack from a variety of logs of the computer system. To do so, a technology for generating a rule for detecting an attack from logs has been developed.

For example, Patent Literature 1 discloses a technology for extracting strings that meet a specific condition from a behavior log of malware and generating a malware detection rule that represents the extracted strings in chronological order. For example, the string is a system call, and the malware detection rule represents a series of system calls.

### CITATION LIST

### Patent Literature

Patent Literature 1: Japanese Unexamined Patent Application Publication No. 2013-092981

### SUMMARY OF INVENTION

### Technical Problem

In the invention disclosed in Patent Literature 1, it is likely that an event that has not occurred due to malware is included in the malware detection rule. This is because not all the system calls that have occurred while malware is running are necessarily related to this malware.

The present disclosure has been made in view of the above-described problem, and an object thereof is to provide a new technique for determining an event related to an attack.

### Solution to Problem

An attack information generation apparatus according to the present disclosure includes: determining means for determining, for each of a plurality of executions of a target attack, the number of occurrences of one or more events by using a log in an execution period thereof; judging means for determining, for each of the events, whether or not the number of occurrences of that event determined for each of the plurality of executions of the target attack satisfies a predetermined condition; and generating means for generating attack information associating the target attack with the event whose number of occurrences is determined to satisfy the predetermined condition.

A control method according to the present disclosure includes: a determining step of determining, for each of a plurality of executions of a target attack, the number of occurrences of one or more events by using a log in an execution period thereof; a determination step of determining, for each of the events, whether or not the number of occurrences of that event determined for each of the plurality of executions of the target attack satisfies a predetermined condition; and a generation step of generating attack information associating the target attack with the event whose number of occurrences is determined to satisfy the predetermined condition.

A non-transitory computer readable medium according to the present disclosure stores a program for causing a computer to perform a control method according to the present disclosure.

### Advantageous Effects of Invention

According to the present disclosure, a new technique for determining an event related to an attack is provided.

### BRIEF DESCRIPTION OF DRAWINGS

FIG. 1 shows an overview of operations performed by attack information generation apparatus according to a first example embodiment;

FIG. 2 is a block diagram showing an example of a functional configuration of the attack information generation apparatus according to the first example embodiment;

FIG. 3 is a block diagram showing an example of a hardware configuration of a computer that implements attack information generation apparatus;

FIG. 4 is a flowchart showing an example of a flow of processes performed by the attack information generation apparatus according to the first example embodiment;

FIG. 5 is a flowchart showing an example of a flow of processes performed by the attack information generation apparatus in a case where attack information is generated for each of a plurality of target attacks;

FIG. 6 conceptually shows an example of a method for determining the number of occurrences of each event;

FIG. 7 shows an example of an attack log in the form of a table;

FIG. 8 shows examples of event identification rules in the form of a table;

FIG. 9 shows an example of a structure of attack information in the form of a table; and

FIG. 10 shows an example of a case where each of attacks is associated with its time length in attack information.

### EXAMPLE EMBODIMENT

An example embodiment according to the present disclosure will be described hereinafter in detail with reference to the drawings. The same reference numerals (or symbols) are assigned to the same or corresponding components/structures throughout the drawings, and redundant descriptions thereof are omitted as appropriate for clarifying the explanation. Further, unless otherwise described, predefined values such as predetermined values and thresholds are stored in advance in a storage device or the like accessible from the apparatus that uses these values.

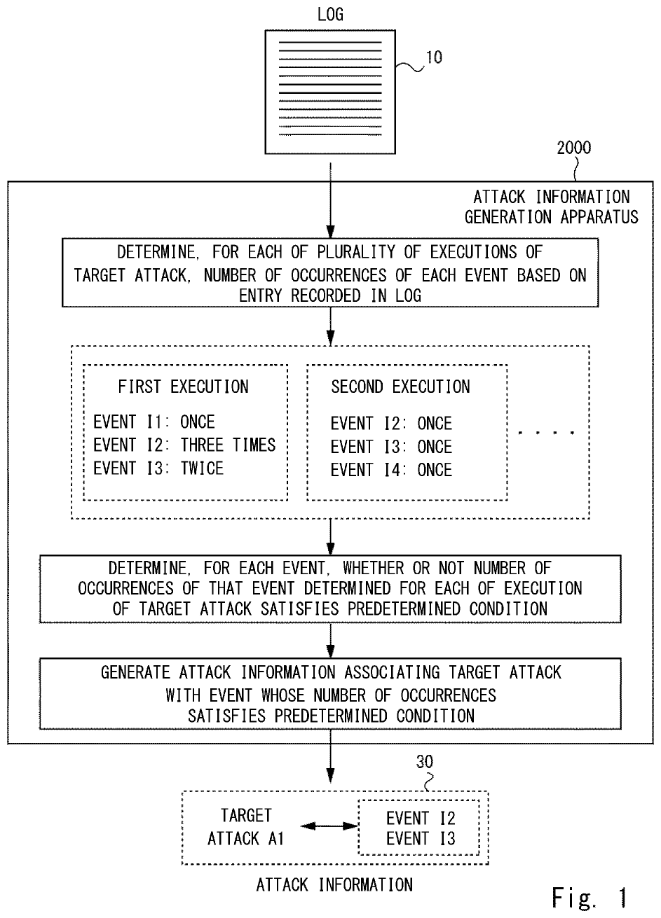

FIG. 1 shows an example of an overview of operations performed by an attack information generation apparatus 2000 according to a first example embodiment. Note that FIG. 1 is a diagram for facilitating the understanding of the overview of the attack information generation apparatus 2000, and the operations performed by the attack information generation apparatus 2000 are not limited to those shown in FIG. 1.

The attack information generation apparatus 2000 associates an attack with an event(s) that is, when the attack is carried out, recorded in a log of an environment in which the attack is carried out (hereinafter referred to as a log 10). Hereafter, information representing this association is called attack information 30. Further, an attack for which the attack information 30 is generated is called a target attack.

Here, an event is any event that occurs in an environment in which a target attack is carried out. For example, the event is an execution of a system call or an API (Application Programing Interface) by a process, an operation on a registry or a file system, or communication through a network. For example, an event is expressed by a combination of its subject, its object, and its content (what is done for what by what?). However, an event may be expressed by information or the like other than the combination of these three information items.

The attack information 30 is generated by using the log 10. The log 10 has a plurality of entries. The entries indicate information about the event that has occurred (the subject of the event, the object thereof, the content thereof, a time at which the event occurred, and the like). The log 10 is, for example, a log of an event recorded by an OS (operating system) or a log about a network flow.

The log 10 includes entries that have been recorded during the execution period of the target attack. To obtain such a log, for example, a test environment in which a target attack can be carried out is prepared, and then the target attack is carried out in this test environment. Then, a log in which events that have occurred in this test environment are recorded is used as the log 10.

The attack information generation apparatus 2000 determines the number of occurrences of each event by detecting, from the log 10, entries indicating the respective events that have occurred during the execution period of the target attack. Note that the target attack is carried out a plurality of times. Therefore, the number of occurrences of the event is determined for each of a plurality of executions of the target attack.

For example, in FIG. 1, regarding the first execution of the target attack, the numbers of occurrences of events I1, I2 and I3 are one, three, and two, respectively. Further, regarding the second execution of the target attack, the numbers of occurrences of events I2, I3 and I4 are all one.

The attack information generation apparatus 2000 determines, for each event, whether or not the number of occurrences of that event determined for each execution of the target attack satisfies a predetermined condition. The predetermined condition is a condition that is satisfied by an event that occurs due to the target attack. By employing such a predetermined condition, it is possible to determine, for each event, whether or not that event occurs due to the target attack. Although details will be described later, as the above-described predetermined condition, for example, a condition such as “a statistical value of the numbers of occurrences of the event is equal to or higher than a threshold” can be used.

The attack information generation apparatus 2000 generates attack information 30 by associating an event whose number of occurrences satisfies the predetermined condition with the target attack. For example, in the attack information 30 shown in FIG. 1, a target attack A1 is associated with events I2 and I3. From this attack information 30, it can be understood that the events I2 and I3 occur due to the target attack A1.

### Example of Advantageous Effect

According to the attack information generation apparatus 2000 in accordance with this example embodiment, for each of a plurality of executions of a target attack, the number of occurrences of each event is determined by using entries in the log 10 that has been recorded during its execution period. Then, an event whose number of occurrences determined for each of the plurality of executions of the target attack satisfies the predetermined condition is associated with the target attack. As described above, according to the attack information generation apparatus 2000, events related to an attack are determined by the new method.

In particular, it is assumed that, as the predetermined condition, a condition that is satisfied by an event that occurs due to a target attack is used. By doing so, it is possible to associate an event that occurs due to a target attack with this target attack based on entries recorded for each of a plurality of executions of the target attack. Then, by analyzing a newly obtained log by using the attack information 30, which shows the above-described association, it is possible, by using the log, to determine that the target attack may have been carried out.

The attack information generation apparatus 2000 according to this example embodiment will be described hereinafter in a more detailed manner.

### <Example of Functional Configuration>

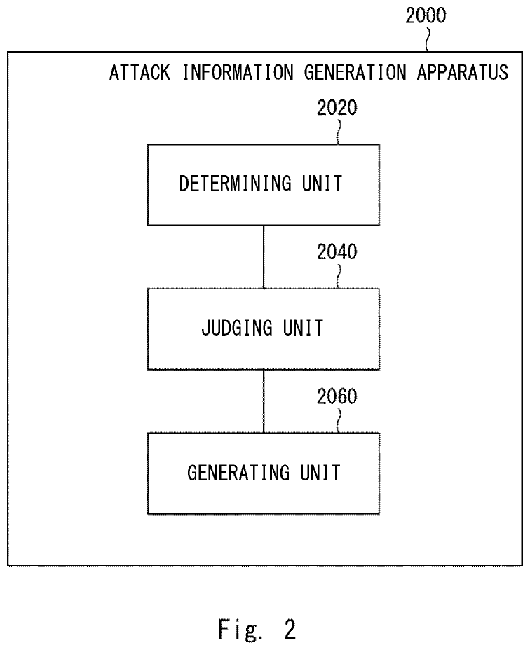

FIG. 2 is a block diagram showing an example of a functional configuration of the attack information generation apparatus 2000 according to the first example embodiment. The attack information generation apparatus 2000 has a determining unit 2020, a judging unit 2040, and a generating unit 2060. For each of a plurality of executions of a target attack, the determining unit 2020 determines, for each of one or more events, the number of occurrences thereof by using entries that have been recorded in a log 10 during its execution period. The judging unit 2040 determines, for each event, whether or not the number of occurrences of that event determined for each execution of the target attack satisfies a predetermined condition. The generating unit 2060 generates attack information 30 associating the target attack with an event whose number of occurrences satisfies the predetermined condition.

### <Example of Hardware Configuration>

Each of the functional components of the attack information generation apparatus 2000 may be implemented either by hardware implementing that functional component (e.g., a hardwired electronic circuit or the like) or by a combination of hardware and software (e.g., a combination of an electronic circuit and a program for controlling the electronic circuit or the like). A case where each of the functional components of the attack information generation apparatus 2000 is implemented by a combination of hardware and software will be further described hereinafter.

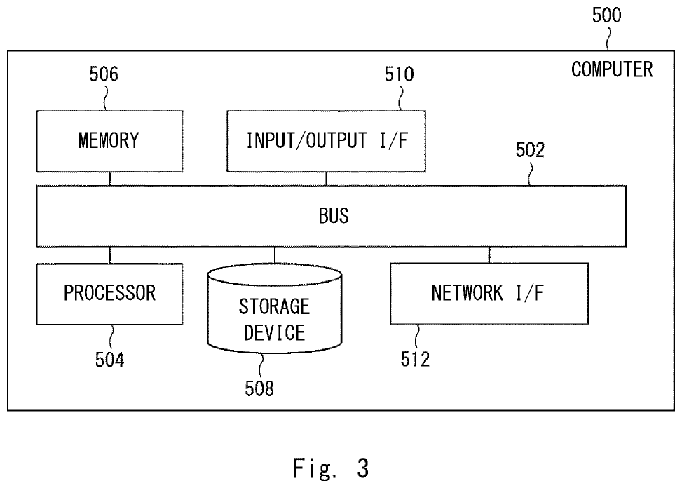

FIG. 3 is a block diagram showing an example of a hardware configuration of a computer 500 that implements the attack information generation apparatus 2000. The computer 500 is an arbitrary computer. For example, the computer 500 is a stationary computer such as a PC (Personal Computer) or a server machine. In another example, the computer 500 is a mobile computer such as a smartphone or a tablet-type terminal. The computer 500 may be a special-purpose computer designed to implement the attack information generation apparatus 2000, or may be a general-purpose computer.

For example, each of the functions of the attack information generation apparatus 2000 is implemented in the computer 500 by installing a certain application(s) in the computer 500. The aforementioned application is constituted by a program for implementing the functional components of the attack information generation apparatus 2000. Note that how to acquire the aforementioned program may be determined as desired. For example, the program can be acquired from a storage medium (such as a DVD or USB memory) in which the program is stored. In another example, the program can be acquired by downloading the program from a server apparatus that manages a storage device in which the program is stored.

The computer 500 includes a bus 502, a processor 504, a memory 506, a storage device 508, an input/output interface 510, and a network interface 512. The bus 502 is a data transmission path through which the processor 504, the memory 506, the storage device 508, the input/output interface 510, and the network interface 512 transmit/receive data to/from each other. However, the method for connecting the processor 504 and the like to each other is not limited to connections through buses.

The processor 504 is any of various types of processors such as a CPU (Central Processing Unit), a GPU (Graphics Processing Unit), or an FPGA (Field-Programmable Gate Array). The memory 506 is a primary memory unit implemented by using a RAM (Random Access Memory) or the like. The storage device 508 is a secondary memory unit implemented by using a hard disk drive, an SSD (Solid State Drive), a memory card, or a ROM (Read Only Memory).

The input/output interface 510 is an interface for connecting the computer 500 with an input/output device(s). For example, an input device such as a keyboard and an output device such as a display device are connected to the input/output interface 510.

The network interface 512 is an interface for connecting the computer 500 to a network. Attacks on the attack information generation apparatus 2000 are carried out, for example, from other machines that are connected to and thereby can communicate with the computer 500 through this network. Note that this network may be a LAN (Local Area Network) or a WAN (Wide Area Network).

In the storage device 508, a program(s) for implementing each of the functional units of the attack information generation apparatus 2000 (a program(s) for implementing the aforementioned application(s)) is stored. The processor 504 realizes each of the functional components of the attack information generation apparatus 2000 by loading this program onto the memory 506 and executing the loaded program.

The attack information generation apparatus 2000 may be implemented on one computer 500 or by a plurality of computers 500. In the latter case, the configurations of the plurality of computers 500 do not necessarily have to be identical to each other, but can be different from each other.

### <Flow of Process>

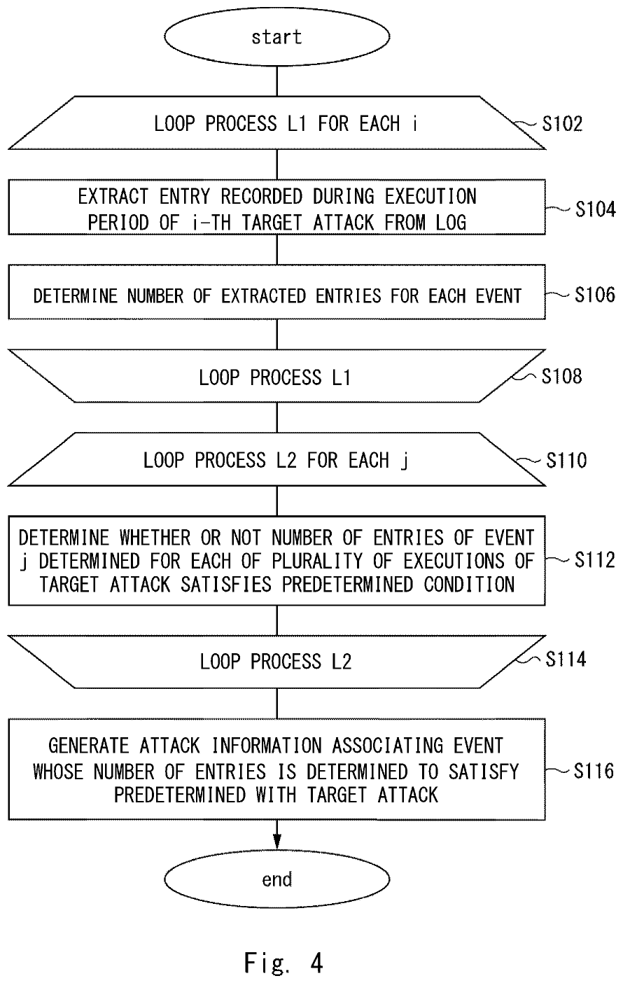

FIG. 4 is a flowchart showing an example of a flow of processes performed by the attack information generation apparatus 2000 according to the first example embodiment. Steps S102 to S108 constitute a loop process L1 which is performed for each of a plurality of executions of a target attack. In the step S102, the attack information generation apparatus 2000 determines whether or not the loop process L1 has already been performed for all of the plurality of executions of the target attack. When the loop process L1 has already been performed for all of the plurality of executions of the target attack, the process shown in FIG. 4 proceeds to a step S112. On the other hand, when there is at least one of the plurality of executions of the target attack for which the loop process L1 has not yet been performed, the attack information generation apparatus 2000 selects one of them. The execution selected in this process is called an i-th execution. After that, the process shown in FIG. 4 proceeds to a step S104.

The determining unit 2020 extracts, from the log 10, entries that have been recorded during the i-th execution of the target attack (S104). The determining unit 2020 determines the number of occurrences of each event based on the extracted entries (S106). Since the step S108 is the end of the loop process L1, the process shown in FIG. 4 proceeds to a step S102.

Steps S110 to S114 constitute a loop process L2 which is performed for each of events that have occurred during the execution period of the target attack. In the step S110, the attack information generation apparatus 2000 determines whether or not the loop process L2 has already been performed for all of the events that have occurred during the execution period of the target attack. When the loop process L2 has already been performed for all the events that have occurred during the execution period of the target attack, the process shown in FIG. 4 proceeds to a step S116. On the other hand, when, among the events that have occurred during the execution period of the target attack, there is one for which the loop process L2 has not yet been performed, the attack information generation apparatus 2000 selects one of them. The event selected in this process is called an event j. After that, the process shown in FIG. 4 proceeds to a step S112.

The judging unit 2040 determines whether or not the number of occurrences of the event j determined for each of the plurality of executions of the target attack satisfies a predetermined condition (S112). Since the step S114 is the end of the loop process L2, the process shown in FIG. 4 proceeds to a step S110.

The generating unit 2060 generates attack information 30 associating the target attack with an event(s) whose number of occurrences is determined to satisfy a predetermined condition (S116).

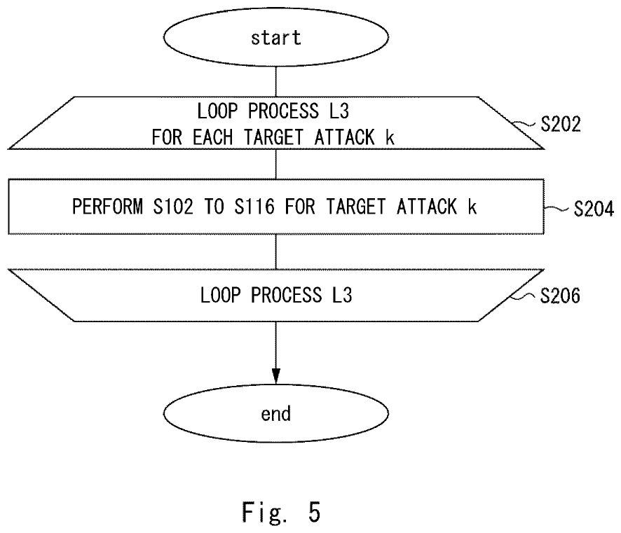

Note that in the flowchart shown in FIG. 4, only for one target attack, an event(s) that is associated with that target attack is determined in the attack information 30. However, the number of the target attacks may be two or more. When attack information 30 is generated for each of a plurality of target attacks, for example, the processes in the steps S102 to S116 are performed for each of the target attacks as shown in FIG. 5. FIG. 5 is a flowchart showing an example of a flow of processes performed by the attack information generation apparatus 2000 in a case where attack information 30 is generated for each of a plurality of target attacks.

### <As to Log 10>

As described above, the log 10 is a log of an environment in which a target attack is carried out. For example, the log 10 is generally classified into 1) a log that is acquired on a machine on which a target attack is carried out (hereinafter also referred to as a target machine) and 2) a log that is acquired on a communication path between the target machine and other machines. Hereafter, the log of 1) is called an endpoint log and the log of 20 is called a network log. Note that the target machine may be a physical machine or may be a virtual machine.

The endpoint log may be, for example, a log about behavior of each of processes running on the target machine, a log about access to a registry, or a log of a file system. The behavior of a process may be represented, for example, by an execution of system calls or other APIs (Application Programming Interfaces), and the like. The network log may be, for example, a log that is recorded by a proxy server disposed on a communication path, a log about a network flow, or a log about packet capturing.

The attack information generation apparatus 2000 may use only one of the above-described various logs and other types of logs as the log 10, or may use a plurality of logs as the log 10.

### <As to Target Attack>

The target attack may be any cyberattack. For example, the target attack may be constituted by one or a plurality of commands. Note that the target attack may be a part of a series of attacks (hereinafter also referred to as an attack sequence) to achieve a certain objective. For example, an attacker who intends to steal important information from a target organization intrudes into a terminal in a network of the target organization, and then examines and collects files stored in the terminal. Further, the attacker searches other terminals where important information is likely to be stored, acquires authentication information or search for a vulnerability in order to expand the intrusion to other terminals, intrudes into other terminals discovered through the search by using the acquired authentication information or the vulnerability information, and expands the range of the search for important information. When the important information is acquired from the terminal, the attacker takes this information to a server of the attacker and terminates the attack.

The target attack does not necessarily have to be an actual attack carried out by a malicious attacker, but may be a pseudo attack carried out by an operator or the like of the attack information generation apparatus 2000 in order to, for example, generate attack information 30. For example, the attack information 30 is generated by carrying out an attack sequence a plurality of times in a test environment and then using a log 10 that has been obtained as a result of the attack sequence. For example, the attack sequence includes attacks A1, A2 and A3. In this case, each of the attacks A1, A2 and A3 is handled as a target attack. For example, in the flowchart shown in FIG. 5, each of a loop process L3 in which the target attack k is the attack A1, another loop process L3 in which the target attack k is the attack A2, and another loop process L3 in which the target attack k is the attack A3 is performed. By doing this, the attack information generation apparatus 2000 generates attack information 30 associating the attack A1 with an event(s) that has occurred due to the attack A1, attack information 30 associating the attack A2 with an event(s) that has occurred due to the attack A2, and attack information 30 associating the attack A3 with an event(s) that has occurred due to the attack A3. However, the attack information generation apparatus 2000 may handle only some of the attacks included in the attack sequence as target attacks.

Note that the target attack may be carried out a plurality of times while changing the configuration of the test environment. In other words, each execution may be carried out in a test environment having a different configuration. The configuration of the test environment that can be changed include, for example, a configuration of log acquisition (a configuration as to what type of event is to be recorded in the log), a configuration of network, or a configuration of firewall. By using the logs 10, which have been acquired by carrying out the target attacks while changing the configuration of the test environment as described above, it is possible to associate, among the events that have occurred due to the target attack, an event(s) that is not significantly affected by the change in the execution environment with the target attack (in other words, it is possible to prevent an event(s) that occurs only in a specific execution environment from being associated with the target attack).

### <Extraction of Entry and Determination of Number of Occurrences of Event: S104, S106>

The determining unit 2020 determines, for each of a plurality of executions of the target attack, the number of occurrences of each event by using entries that have been recorded in the log 10 during its execution period (S106). To this end, for example, the determining unit 2020 extracts, for each of the plurality of executions of the target attack, entries that have been recorded during its execution period from the log 10 (S104). Hereafter, a set of entries extracted from the log 10 during the execution period of an i-th target attack is called an entry group i.

Note that the determining unit 2020 may acquire the log 10 by using an arbitrary method. For example, the determining unit 2020 acquires the log 10 from a storage device accessible from the determining unit 2020. In another example, the determining unit 2020 may transmit a request to an apparatus that manages the log 10 (such as a database server) and acquire the log 10 that is sent in response to the request.

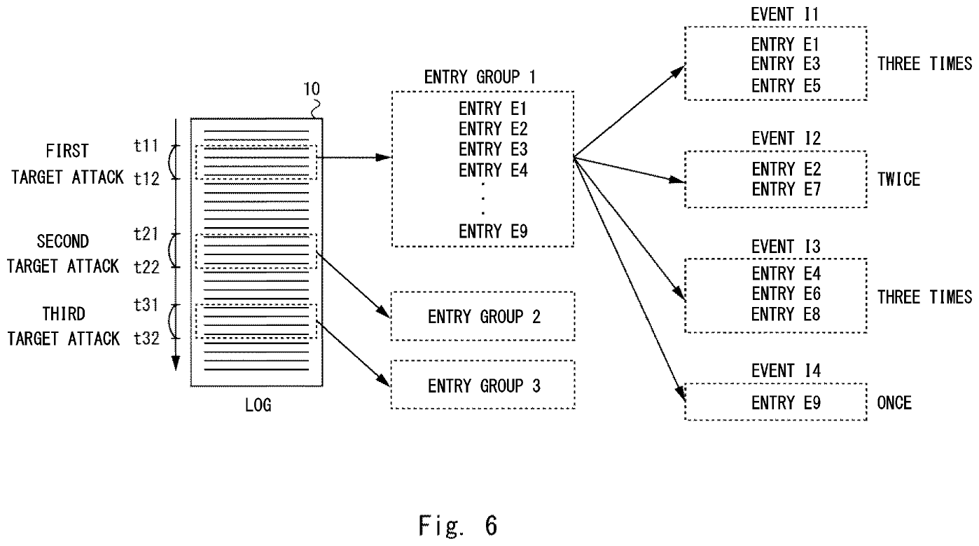

For each entry group, the determining unit 2020 classifies the entries included in that entry group according to the event. FIG. 6 conceptually shows an example of a method for determining the number of occurrences of each event. In this example, the target attack is carried out three times. The execution periods of the first to third target attacks are a period from t11 to t12, a period from t21 to t22, and a period from t31 to t32, respectively. Therefore, the entry group for the first target attack includes entries that have been recorded in the log in the period from the time t11 to t12. Similarly, the entry group for the second target attack includes entries that have been recorded in the log 10 in the period from the time t21 to t22, and the entry group for the third target attack includes entries that have been recorded in the log 10 in the period from the time t31 and t32.

The determining unit 2020 summarizes entries for each entry group. FIG. 6 shows how the entry group 1 generated for the first target attack is summarized. The determining unit 2020 divides the entries included in the entry group 1 into groups of entries indicating respective events. In this example, entries E10 through E9 included in the entry group 1 are classified into a group composed of “E1, E3 and E5”, a group composes of “E2 and E7”, a group composed of “E4, E6 and E8”, and a group composed of “E9.” Note that an identifier I1 is assigned to the event represented by the entries E1, E3, and E5; an identifier I2 is assigned to the event represented by the entries E2 and E7; an identifier I3 is assigned to the event represented by the entries E4, E6 and E8; and an identifier I4 is assigned to the event represented by the entry E9.

The determining unit 2020 determines, for each of the events, the number of occurrences of that event based on the number of entries corresponding to that event. For example, the determining unit 2020 handles the number of entries corresponding to a given event as the number of occurrences of that event. For example, in the case of the example shown in FIG. 6, the numbers of entries corresponding to the events I1, I2, I3 and I4 are 3, 2, 3 and 1, respectively. Therefore, the numbers of occurrences of the events I1, I2, I3 and I4 are 3, 2, 3 and 1, respectively.

In another example, the determining unit 2020 may regards the number of occurrences of an event as zero when there is no entry corresponding to that event (when the number of entries is zero), whereas the determining unit 2020 may regards the number of occurrences of an event as one when there is an entry corresponding to that event (when the number of entries is at least one). That is, in this case, for each target attack, the presence or absence of each event is determined. For example, in the case shown in FIG. 6, the numbers of occurrences of the events I1 to I4 are all regarded as one.

### <<Determination of Execution Period of Target Attack>>

In order to extract entries that have been recorded during the execution period of the target attack from the log 10, it is necessary that the execution period of the target attack can be determined. To do so, for example, when a target attack is carried out, information indicating the start time of its execution and the end time thereof (hereinafter also referred to as an attack log) is put in an arbitrary storage device. The determining unit 2020 determines the execution period of the target attack by using the attack log.

Note that an existing technique can be used to record the start time of an attack and the end time thereof. For example, when a target attack is carried out by using a script in which the start time of the execution is scheduled in advance, the time that is scheduled as the start time of the execution in the script is recorded as the start time of the attack in the attack log. Further, in this case, the end time of the execution scheduled in the script is recorded as the end time of the attack in the attack log. In another example, in a case where an operator or the like manually carries out a target attack, the start time of the execution and the end time thereof may be recorded by the operator or the like in the attack log.

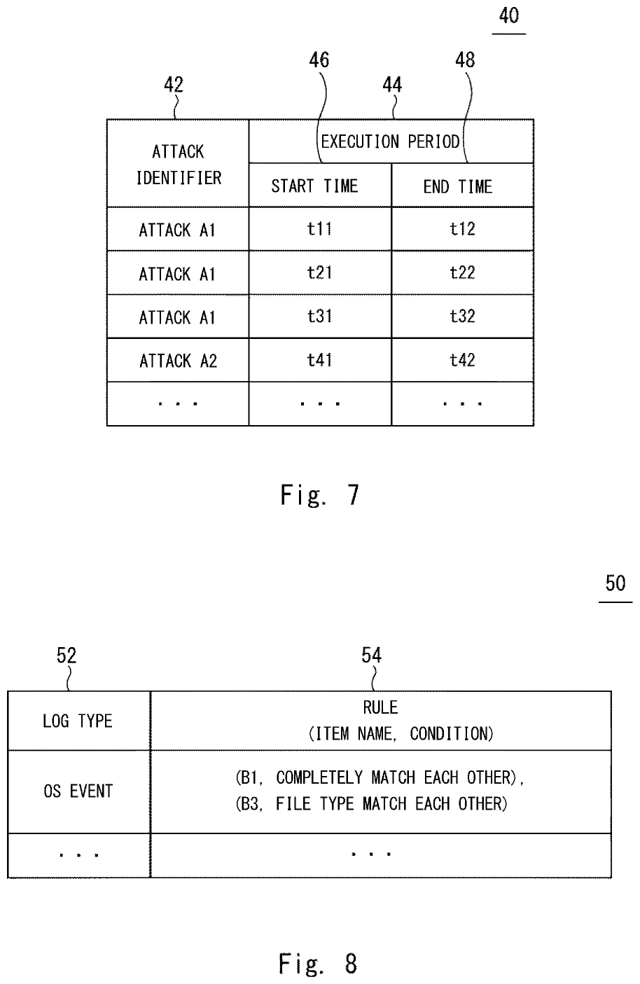

FIG. 7 shows an example of an attack log in the form of a table. The attack log 40 shown in FIG. 7 includes Attack Identifier 42 and Execution Period 44. The attack identifier 42 indicates an identifier by which the target attack can be determined. The execution period 44 includes Start Time 46 indicating start time of the target attack, and End Time 48 indicating end time of the target attack.

### <<Identification of Event>>

In order to divide entries on an event-by-event basis, it is necessary to identify an event represented by each entry. That is, it is necessary to determine whether a plurality of entries indicate the same event or different events by using some criteria or the like. An example of a specific method for this determination will be described hereinafter.

For example, the determining unit 2020 handles entries having the same value as each other for at least one predetermined item as those representing the same event as each other. As the item for entries, there may be various items representing, for example, the subject of the event, the object thereof, and the content thereof. When an event is identified based on the value of an item, a rule for determining information as to which item should be used to identify the event (hereinafter also referred to as an event identification rule) is stored in advance in an arbitrary storage device in such a manner that the determining unit 2020 can acquire the rule therefrom. The determining unit 2020 divides a plurality of entries included in an entry group into combinations of entries representing respective events by using the event identification rule.

For example, assume that each entry in the log 10 has five items B1 to B5. Assume also that an event identification rule that “Entries having the same values as each other for items B2 and B4 represent the same event as each other” is defined in advance. In this case, the determining unit 2020 compares the values of the items B2 and B4 of the entries included in the entry group with one another. Then, a combination of a plurality of entries that satisfy the condition “Values of item B2 are the same as each other, and values of item B4 are the same as each other” is extracted as a combination of entries representing the same event.

Note that not only entries having the same values as each other for an item(s) but also entries having similar values to each other for an item(s) may also be handled as entries representing the same event. For example, regarding an item “Accessed File”, among a plurality of entries, not only a case where the names of the accessed files completely match each other, but also a case where directories where the accessed files are stored match each other (i.e., a case where paths of the files match each other halfway) or a case where the types of the accessed files match each other (e.g., the extensions of the files match each other) may be handled as the case where the entries represent the same event as each other.

Note that items included in logs may differ according to the type of the log. Therefore, when a plurality of types of logs are handled as the logs 10, the above-described event identification rule is defined in advance for each of the plurality of types of logs.

FIG. 8 shows examples of event identification rules in the form of a table. The event identification rule 50 has Log Type 52 and Rule 54. The log type 52 indicates types of logs 10 to which rules shown in the rule 54 are applied. The rule 54 indicates at least one pair of an item name and an identification condition. For example, in the example shown in FIG. 8, a combination of a plurality of entries that satisfy the condition “Values of item B1 match each other, and file types shown in item B3 match each other” is handled as a combination of entries representing the same event as each other.

However, in the case where a plurality of pairs is shown in the rule 54, the meaning expressed by the rule 54 may not be limited to the meaning that “all the conditions of all the pairs should be satisfied”. For example, a condition “Pair 1 and pair 2 or pair 3” or the like is allowed to be defined in the rule 54, so that various rules can be defined by a plurality of pairs in a flexible manner.

### <Determination Whether or not Predetermined Condition is Satisfied: S112>

The judging unit 2040 determines, for each event, whether or not the number of occurrences of that event satisfies a predetermined condition (S112). For example, as described above, a condition that is satisfied by an event that has occurred due to the target attack is used as the predetermined condition. It should be noted that it is considered that when a given event occurs due to a target attack, that event occurs in all or most of a plurality of executions of that target attack. Therefore, for example, as the predetermined condition that is satisfied by an event that occurs due to a target attack, a condition that is satisfied by an event that occurs in all or most of a plurality of executions of that target attack can be used.

Such a predetermined condition is defined, for example, by a condition related to a statistical value (such as a mean value, a median, a mode, or a minimum value) of the number of occurrences of an event. Specifically, the predetermined condition is, for example, a condition that “Statistical value of the number of occurrences of the event is equal to or larger than a threshold”. In this case, the judging unit 2040 computes, for each event, a statistical value of the number of occurrences of that event in each of a plurality of executions of the target attack, and determines whether or not this statistical value is equal to or larger than a threshold. When the above-described statistical value computed for a given event is equal to or larger than the threshold, it means that the predetermined condition for the number of occurrences of that event is satisfied. On the other hand, when the above-described statistical value calculated for the event is lower than the threshold, it means that the predetermined condition for the number of occurrences of that event is not satisfied.

### <Generation of Attack Information 30: S116>

The generating unit 2060 generates attack information 30 associating a target attack with an event whose number of occurrences is determined to satisfy a predetermined condition (S116). When a condition that is satisfied by an event that occurs in all or most of a plurality of executions of a target attack is used as the predetermined condition, the attack information 30 becomes information associating the target attack with the event that occurs due to the target attack.

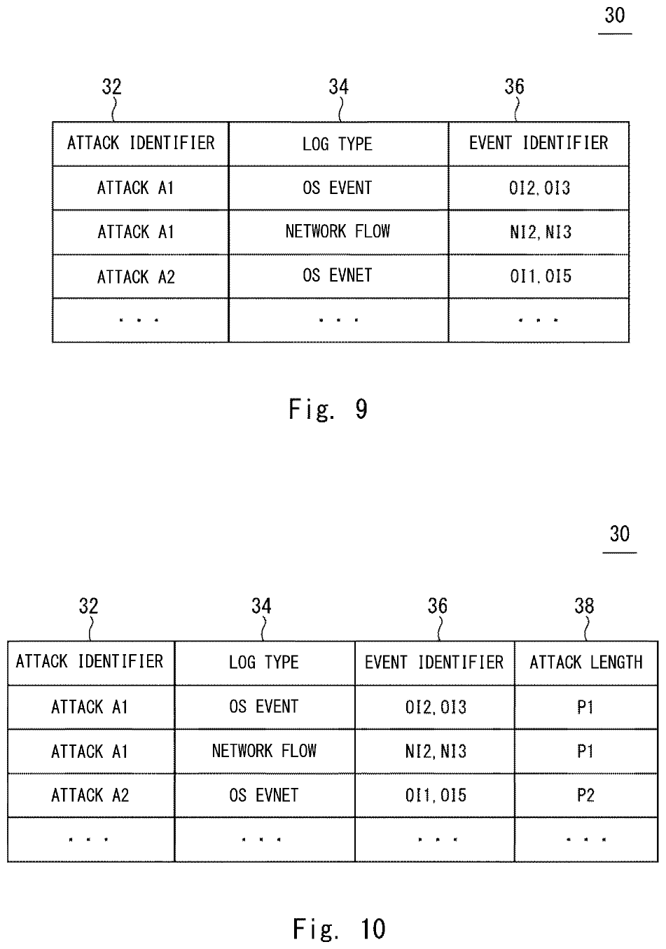

FIG. 9 shows an example of a structure of attack information 30 in the form of a table. In FIG. 9, the attack information 30 has Attack Identifier 32, Log Type 34, and Event Identifier 36. The attack identifier 32 indicates identifiers assigned to attacks. Any information by which an attack can be identified can be used for the attack identifier 32. For example, a name of an attack is used for the attack identifier 32. In another example, the attack identifier 32 may be represented by a combination of a name of an attack and its configuration. For example, when a command whose behavior changes according to its argument(s) is used as an attack, the attack identifier 32 can be represented by a combination of “the command name and the argument(s)”.

The log type 34 indicates a type of log that is used to generate attack information 30. Any information by which an event can be identified can be used for the event identifier 36. For example, when the event identification rule 50 is used to identify an event, the generating unit 2060 generates the event identifier 36 based on the value of an item(s) determined by the rule 54. For example, assume that an event is identified based on a rule “Process names match each other, and accessed file types match each other”. In this case, for example, the event identifier 36 is represented by a pair of a process name and a file type.

Note that when a plurality of events each of which the number of occurrences satisfies the predetermined condition is determined for the same target attack and the same log 10, the identifiers of the plurality of events are shown in the event identifier 36. That is, the plurality of events is associated with a pair of “the target attack and the log type”. This means that since the plurality of events occur due to the execution of the target attack, a plurality of entries respectively indicating the plurality of events are recorded in the same log 10.

For example, in the first line shown in FIG. 9, “Event Identifiers=O12, O13” are associated with a combination of “Attack identifier=Attack A1” and “Log Type=OS Event”. Therefore, when both an entry indicating an event whose event identifier is O12 and an entry indicating an event whose event identifier is O13 are included in the log of the OS event, it is likely that the attack A1 has been made.

### <Output of Attack Information 30>

The generating unit 2060 may output attack information 30 in an arbitrary manner. For example, the generating unit 2060 put attack information 30 in a storage device accessible from the attack information generation apparatus 2000. For example, the attack information 30 stored in the storage device is used by an attack detection apparatus (which will be described later). In another example, the generating unit 2060 displays the attack information 30 on a display device accessible from the attack information generation apparatus 2000. In another example, the generating unit 2060 transmits the attack information 30 to an arbitrary apparatus. For example, the destination to which the attack information 30 is sent is an attack detection apparatus (which will be described later).

### <Detection of Attack Using Attack Information 30>

It is conceivable, as a method for using attack information 30, to use a log generated in an actual operating environment of a computer system for a process for detecting a possible attack that may have been carried out for the computer system. A method for detecting a possible attack carried out for a computer system by using attack information 30 will be described hereinafter. Note that a computer system for which the detection of an attack is performed is called an inspection target system, and a log acquired in the execution environment of the inspection target system is called an inspection target log. Further, an apparatus that performs a process for detecting an attack by using attack information 30 is called an attack detection apparatus.

The attack detection apparatus may be provided as an integrated part of the attack information generation apparatus 2000, or may be implemented as a separate apparatus or the like. In other words, the attack detection apparatus may be implemented by the computer 500 together with the attack information generation apparatus 2000, or may be implemented by another computer. In the latter case, the computer implementing the attack information generation apparatus 2000 has, for example, a hardware configuration shown in FIG. 3 as in the case of the computer 500.

For example, the attack detection apparatus detects one or more events associated with the same attack (hereinafter also referred to as an event group) in the attack information 30 from the inspection target log. When a given event group is detected from the inspection target log, the attack detection apparatus detects an attack associated with that event group as a possible attack that may have been carried out for the inspection target system. Note that as described above, the attack information 30 can be generated by using a plurality of logs 10. Therefore, the attack detection apparatus detects an event group by using, among the logs acquired from the execution environment of the inspection target system, the same type of log as that shown in the log type 34 as the inspection target log.

The attack detection apparatus may detect an event group by also taking time required for the attack into consideration. That is, the attack detection apparatus may detect, only when an event group is included within a specific time window, an attack associated with this event group as an attack carried out for the inspection target system. By detecting an attack while taking the time required for the attack into consideration as described above, it is possible to detect an attack that may have been carried out for the inspection target system more accurately.

The time length of the attack may be common to all attacks or may be specified for each attack. In the latter case, the attack information 30 should include information about the time length of the attack. FIG. 10 shows an example of a case in which each of attacks is associated with its time length in the attack information 30. The attack information 30 shown in FIG. 10 has Attack Length 38. The attack length 38 indicates the lengths of the execution periods of corresponding attacks.

When the attack information 30 includes an attack length 38 as shown in FIG. 10, the generating unit 2060 determines, for example, a value to be set to the attack length 38 based on the length of the execution period of the target attack. For example, the generating unit 2060 determines, for each of a plurality of executions of a target attack, the length of the execution period of that execution by using the attack log 40, and sets a statistical value of the determined lengths of the execution periods to the attack length 38. For example, the statistical value may be a mean value, a median, a mode, a maximum value, or a minimum value.

Although the present invention is described above with reference to example embodiments, the present invention is not limited to the above-described example embodiments. Various modifications that can be understood by those skilled in the art can be made to the configuration and details of the present invention within the scope of the invention.

Note that, in the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM, CD-R, CD-R/W, and semiconductor memories (such as mask ROM, PROM (Programmable ROM), EPROM (Erasable PROM), flash ROM, RAM, etc.). Further, the program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the embodiments disclosed above can be described as, but not limited to, the following supplementary notes.

### (Supplementary Note 1)

An attack information generation apparatus comprising:
determining means for determining, for each of a plurality of executions of a target attack, the number of occurrences of one or more events by using a log in an execution period thereof;
judging means for determining, for each of the events, whether or not the number of occurrences of that event determined for each of the plurality of executions of the target attack satisfies a predetermined condition; and generating means for generating attack information associating the target attack with the event whose number of occurrences is determined to satisfy the predetermined condition.

### (Supplementary Note 2)

The attack information generation apparatus according to Supplementary note 1, wherein the predetermined condition is a condition that a statistical value of the numbers of occurrences of the event determined for each of the plurality of executions of the target attack is equal to or larger than a threshold.

### (Supplementary Note 3)

The attack information generation apparatus according to Supplementary note 1 or 2,
wherein the determining means performs:
defining the number of occurrences of the event for which there is a corresponding entry in the log in the execution period of the target attack as one; and
defining the number of occurrences of the event for which there is no corresponding entry in the log in the execution period of the target attack as zero.

### (Supplementary Note 4)

The attack information generation apparatus according to any one of Supplementary notes 1 to 3,
wherein the determining means performs:
determining, among a plurality of entries recorded in the execution period of the target attack in the log, entries that have values matching each other or similar to each other in at least one predetermined item as entries representing the same event; and
determining, for each of the events, the number of occurrences of that event based on the number of the entries determined as those representing that event.

### (Supplementary Note 5)

The attack information generation apparatus according to any one of Supplementary notes 1 to 4, wherein the generating means determines a length of the execution period of the target attack and includes this length of the execution period in the attack information.

### (Supplementary Note 6)

The attack information generation apparatus according to Supplementary note 5, wherein the length of the execution period of the target attack included in the attack information is a statistical value of lengths of execution periods of the target attack that has been carried out a plurality of times.

### (Supplementary Note 7)

The attack information generation apparatus according to any one of Supplementary notes 1 to 6, wherein at least two of the plurality of executions of the target attack are carried out in test environments different from each other.

### (Supplementary Note 8)

The attack information generation apparatus according to any one of Supplementary notes 1 to 7,
wherein the determining means determines the number of occurrences of each of the events for each of the plurality of types of logs, and
wherein the generating means includes, in the attack information, the type of log from which an entry indicating the event has been extracted.

### (Supplementary Note 9)

A control method performed by a computer, comprising:
a determining step of determining, for each of a plurality of executions of a target attack, the number of occurrences of one or more events by using a log in an execution period thereof;
a determination step of determining, for each of the events, whether or not the number of occurrences of that event determined for each of the plurality of executions of the target attack satisfies a predetermined condition; and
a generation step of generating attack information associating the target attack with the event whose number of occurrences is determined to satisfy the predetermined condition.

### (Supplementary Note 10)

The control method according to Supplementary note 9, wherein the predetermined condition is a condition that a statistical value of the numbers of occurrences of the event determined for each of the plurality of executions of the target attack is equal to or larger than a threshold.

### (Supplementary Note 11)

The control method according to Supplementary note 9 or 10, further comprising in the determining step:
defining the number of occurrences of the event for which there is a corresponding entry in the log in the execution period of the target attack as one; and
defining the number of occurrences of the event for which there is no corresponding entry in the log in the execution period of the target attack as zero.

### (Supplementary Note 12)

The control method according to any one of Supplementary notes 9 to 11, further comprising in the determining step:
determining, among a plurality of entries recorded in the execution period of the target attack in the log, entries that have values matching each other or similar to each other in at least one predetermined item as entries representing the same event; and
determining, for each of the events, the number of occurrences of that event based on the number of the entries determined as those representing that event.

### (Supplementary Note 13)

The control method according to any one of Supplementary notes 9 to 12, further comprising in the generating step: determining a length of the execution period of the target attack, and including this length of the execution period in the attack information.

### (Supplementary Note 14)

The control method according to Supplementary note 13, wherein the length of the execution period of the target attack included in the attack information is a statistical value of lengths of execution periods of the target attack that has been carried out a plurality of times.

### (Supplementary Note 15)

The control method according to any one of Supplementary notes 9 to 13, wherein at least two of the plurality of executions of the target attack are carried out in test environments different from each other.

### (Supplementary Note 16)

The control method according to any one of Supplementary notes 9 to 15, further comprising:
in the determining step, determining the number of occurrences of each of the events for each of the plurality of types of logs; and
in the generating step, including, in the attack information, the type of log from which an entry indicating the event has been extracted.

### (Supplementary Note 17)

A non-transitory computer readable medium storing a program for causing a computer to perform:
a determining step of determining, for each of a plurality of executions of a target attack, the number of occurrences of one or more events by using a log in an execution period thereof;
a determination step of determining, for each of the events, whether or not the number of occurrences of that event determined for each of the plurality of executions of the target attack satisfies a predetermined condition; and
a generation step of generating attack information associating the target attack with the event whose number of occurrences is determined to satisfy the predetermined condition.

### (Supplementary Note 18)

The non-transitory computer readable medium according to Supplementary note 17, wherein the predetermined condition is a condition that a statistical value of the numbers of occurrences of the event determined for each of the plurality of executions of the target attack is equal to or larger than a threshold.

### (Supplementary Note 19)

The non-transitory computer readable medium according to Supplementary note 17 or 18,
wherein in the determining step:
defining the number of occurrences of the event for which there is a corresponding entry in the log in the execution period of the target attack as one; and
defining the number of occurrences of the event for which there is no corresponding entry in the log in the execution period of the target attack as zero.

### (Supplementary Note 20)

The non-transitory computer readable medium according to any one of Supplementary notes 17 to 19,
wherein in the determining step:
determining, among a plurality of entries recorded in the execution period of the target attack in the log, entries that have values matching each other or similar to each other in at least one predetermined item as entries representing the same event; and
determining, for each of the events, the number of occurrences of that event based on the number of the entries determined as those representing that event.

### (Supplementary Note 21)

The non-transitory computer readable medium according to any one of Supplementary notes 17 to 20,
wherein the generating step, determining a length of the execution period of the target attack, and including this length of the execution period in the attack information.

### (Supplementary Note 22)

The non-transitory computer readable medium according to Supplementary note 21, wherein the length of the execution period of the target attack included in the attack information is a statistical value of lengths of execution periods of the target attack that has been carried out a plurality of times.

### (Supplementary Note 23)

The non-transitory computer readable medium according to any one of Supplementary notes 17 to 22, wherein at least two of the plurality of executions of the target attack are carried out in test environments different from each other.

### (Supplementary Note 24)

The non-transitory computer readable medium according to any one of Supplementary notes 17 to 23,
wherein in the determining step, determining the number of occurrences of each of the events for each of the plurality of types of logs; and
in the generation step, including, in the attack information, the type of log from which an entry indicating the event has been extracted.

This application is based upon and claims the benefit of priority from Japanese patent application No. 2020-215074, filed on Dec. 24, 2020, the disclosure of which is incorporated herein in its entirety by reference.

### REFERENCE SIGNS LIST

10 LOG
30 ATTACK INFORMATION
32 ATTACK IDENTIFIER
34 LOG TYPE
36 EVENT IDENTIFIER
38 ATTACK LENGTH
40 ATTACK LOG
42 ATTACK IDENTIFIER
44 EXECUTION PERIOD
46 START TIME
48 END TIME
50 EVENT IDENTIFICATION RULE
52 LOG TYPE
54 RULE
500 COMPUTER
502 BUS
504 PROCESSOR
506 MEMORY
508 STORAGE DEVICE
510 INPUT/OUTPUT INTERFACE
512 NETWORK INTERFACE
2000 ATTACK INFORMATION GENERATION APPARATUS
2020 DETERMINING UNIT
2040 JUDGING UNIT
2060 GENERATING UNIT

1. An attack information generation apparatus comprising:
at least one memory storing instructions; and
at least one processor that is configured to execute the instructions to:
determine, for each of a plurality of executions of a target attack, the number of occurrences of one or more events by using a log recorded in an execution period of the target attack;
determine, for each of the events, whether or not the number of occurrences of that event determined for each of the plurality of executions of the target attack satisfies a predetermined condition; and
generate attack information associating the target attack with the event whose number of occurrences is determined to satisfy the predetermined condition.

2. The attack information generation apparatus according to claim 1, wherein the predetermined condition is a condition that a statistical value of the numbers of occurrences of the event determined for each of the plurality of executions of the target attack is equal to or larger than a threshold.

3. The attack information generation apparatus according to claim 1,
wherein the at least one processor is further configured to:
define the number of occurrences of the event for which there is a corresponding entry in the log in the execution period of the target attack as one; and
define the number of occurrences of the event for which there is no corresponding entry in the log in the execution period of the target attack as zero.

4. The attack information generation apparatus according to claim 1,
wherein the at least one processor is further configured to:
determine, among a plurality of entries recorded in the execution period of the target attack in the log, entries that have values matching each other or similar to each other in at least one predetermined item as entries representing the same event; and
determine, for each of the events, the number of occurrences of that event based on the number of the entries determined as those representing that event.

5. The attack information generation apparatus according to claim 1, wherein the at least one processor is further configured to:
determine a length of the execution period of the target attack; and
include this length of the execution period in the attack information.

6. The attack information generation apparatus according to claim 5, wherein the length of the execution period of the target attack included in the attack information is a statistical value of lengths of execution periods of the target attack that has been carried out a plurality of times.

7. The attack information generation apparatus according to claim 1, wherein at least two of the plurality of executions of the target attack are carried out in test environments different from each other.

8. The attack information generation apparatus according to claim 1,
wherein the at least one processor is further configured to:
determine the number of occurrences of each of the events for each of the plurality of types of logs; and
include, in the attack information, the type of log from which an entry indicating the event has been extracted.

9. A control method performed by a computer, comprising:
determining, for each of a plurality of executions of a target attack, the number of occurrences of one or more events by using a log recorded in an execution period of the target attack;
determining, for each of the events, whether or not the number of occurrences of that event determined for each of the plurality of executions of the target attack satisfies a predetermined condition; and
generating attack information associating the target attack with the event whose number of occurrences is determined to satisfy the predetermined condition.

10. The control method according to claim 9, wherein the predetermined condition is a condition that a statistical value of the numbers of occurrences of the event determined for each of the plurality of executions of the target attack is equal to or larger than a threshold.

11. The control method according to claim 9, further comprising:
defining the number of occurrences of the event for which there is a corresponding entry in the log in the execution period of the target attack as one; and
defining the number of occurrences of the event for which there is no corresponding entry in the log in the execution period of the target attack as zero.

12. The control method according to claim 9, further comprising:
determining, among a plurality of entries recorded in the execution period of the target attack in the log, entries that have values matching each other or similar to each other in at least one predetermined item as entries representing the same event; and
determining, for each of the events, the number of occurrences of that event based on the number of the entries determined as those representing that event.

13. The control method according to claim 9, further comprising:
determining a length of the execution period of the target attack; and
including this length of the execution period in the attack information.

14. The control method according to claim 13, wherein the length of the execution period of the target attack included in the attack information is a statistical value of lengths of execution periods of the target attack that has been carried out a plurality of times.

15. The control method according to claim 9, wherein at least two of the plurality of executions of the target attack are carried out in test environments different from each other.

16. The control method according to claim 9, further comprising:
determining the number of occurrences of each of the events for each of the plurality of types of logs; and
including, in the attack information, the type of log from which an entry indicating the event has been extracted.

17. A non-transitory computer readable medium storing a program for causing a computer to perform:
determining, for each of a plurality of executions of a target attack, the number of occurrences of one or more events by using a log recorded in an execution period of the target attack;
determining, for each of the events, whether or not the number of occurrences of that event determined for each of the plurality of executions of the target attack satisfies a predetermined condition; and
generating attack information associating the target attack with the event whose number of occurrences is determined to satisfy the predetermined condition.

18. The non-transitory computer readable medium according to claim 17, wherein the predetermined condition is a condition that a statistical value of the numbers of occurrences of the event determined for each of the plurality of executions of the target attack is equal to or larger than a threshold.

19. The non-transitory computer readable medium according to claim 17,
wherein the program further causes the computer to perform:
defining the number of occurrences of the event for which there is a corresponding entry in the log in the execution period of the target attack as one; and
defining the number of occurrences of the event for which there is no corresponding entry in the log in the execution period of the target attack as zero.

20. The non-transitory computer readable medium according to claim 17,
wherein the program further causes the computer to perform:
determining, among a plurality of entries recorded in the execution period of the target attack in the log, entries that have values matching each other or similar to each other in at least one predetermined item as entries representing the same event; and
determining, for each of the events, the number of occurrences of that event based on the number of the entries determined as those representing that event.

21. The non-transitory computer readable medium according to claim 17,
wherein the program further causes the computer to perform:
determining a length of the execution period of the target attack; and
including this length of the execution period in the attack information.

22. The non-transitory computer readable medium according to claim 21, wherein the length of the execution period of the target attack included in the attack information is a statistical value of lengths of execution periods of the target attack that has been carried out a plurality of times.

23. The non-transitory computer readable medium according to claim 17, wherein at least two of the plurality of executions of the target attack are carried out in test environments different from each other.

24. The non-transitory computer readable medium according to claim 17,
wherein the program further causes the computer to perform:
determining the number of occurrences of each of the events for each of the plurality of types of logs; and
including, in the attack information, the type of log from which an entry indicating the event has been extracted.
